(19) United States
(12) Patent Application Publication
(10) Pub. No.: US 2011/0100669 A1
(43) Pub. Date: May 5, 2011

(54) JUNCTION BOX APPLICABLE TO A PHOTOVOLTAIC MODULE

(75) Inventors: Chi Lai LEE, PingZhen City (TW); Hsieh-Hsin Yeh, Sanchong City (TW); Hsuan-Ping Chen, Qiaotou Township (TW)

(73) Assignee: DU PONT APOLLO LTD., Pak Shek Kok (HK)

(21) Appl. No.: 12/916,178

(22) Filed: Oct. 29, 2010

Related U.S. Application Data
(60) Provisional application No. 61/256,387, filed on Oct. 30, 2009.

(51) Int. Cl. H02G 3/08

(52) U.S. Cl. 174/50

(57) ABSTRACT

The present invention provides a junction box configured to be used with a photovoltaic module. The junction box comprises a central connecting portion adapted to receive metallic ribbons extended from the photovoltaic module, and a peripheral portion enclosing the central connecting portion. The peripheral portion comprises a plurality of recesses defined therein, and each of the recesses is adapted to receive a snap ring of a cable. Further, each of the recesses has an opening to the exterior of the junction box, and a channel communicating with the central connection portion. The opening and the channel of the recess define a longitudinal axis extending toward the central connection portion. The junction box of the present invention allows cables to be coupled to the photovoltaic module in multiple directions.

### FIELD OF THE INVENTION

The present invention relates to a junction box, in particular related to a junction box for use with a photovoltaic module (PV module).

### BACKGROUND OF THE INVENTION

Solar energy has been widely applied as a power source in a variety of technical fields. It is regarded as a clean energy source that produces almost no pollution and is harmless to the environment. The most common means of using solar energy is to transform it into the electricity by photovoltaic cells (PV cells). In order to obtain a desired voltage, a number of PV cells may be enclosed in an individual PV module, and each PV cell has a positive output and a negative output electrically connected to common positive and negative output wires, respectively. The terminals of the positive and negative outputs typically pass through the back sheet. After the positive and negative outputs are soldered onto the outside of the PV module, it is necessary to connect the positive and negative outputs with a positive output cable and a negative output cable, respectively, to convey the electric current from the PV module, so that the electric current can be used for its intended purpose.

Generally speaking, one end of each of the cables is soldered to the positive and negative outputs on the back sheet of the PV module. To protect these soldered connections from damage or short circuit, a protective structure, commonly called as a “junction box”, is positioned and secured over these soldered connections. The junction box is filled with a protective sealant, such as epoxy, to cover and protect these soldered connections.

Conventional junction box has two openings defined therein to receive the two output cables. FIG. 1 illustrates one type of conventional junction box. As shown in FIG. 1, two openings 122 and 124 are defined on the same side of the junction box 12 which is attached to the PV module 10 to receive the two output cables 142 and 144. In other words, both of the two output cables extend from the same side of the junction box 12 (this type of the junction box is hereinafter called as “bottom type”).

Alternatively, the two openings may be defined in the opposite sides of the junction box to receive the two output cables. U.S. published application 20060180196 A1 is an example of such opposite type junction box. As shown in FIG. 2, the two openings 202 and 204 are defined in two opposite sides of the junction box 20, so that the two output cables 222 and 224 are able to respectively connect to the two opposite sides to output the electricity generated by the adjacent PV module (not shown).

The electric connection to adjacent PV module, however, limits the usage of the traditional junction box. Specifically speaking, since the conventional junction box, be it bottom type or opposite type, has fixed openings, the usage of the junction box is highly restricted when it is electrically connected to the adjacent PV module by the output cables. Moreover, in order to electrically connect the adjacent PV module with the output cables, it is necessary to curve the output cables, and the cables may be damaged inadvertently. Further, to curve the output cables, the output cables should be long enough to avoid damage, and this increases the difficulty of installation. Accordingly, it is necessary to provide an improved junction box to solve the above problems.

### SUMMARY OF THE INVENTION

The object of the present invention is to provide a junction box that can receive cables in different directions so that the cables can avoid unnecessary damage caused by bending the same during installation.

Another object of the present invention is to provide a junction box that can receive cables so that the cables cannot be easily removed therefrom.

To achieve the above objects, the present invention discloses a junction box configured to be used with a photovoltaic module. The junction box comprises a central connecting portion adapted to receive metallic ribbons extended from the photovoltaic module, and a peripheral portion enclosing the central connecting portion and comprising a plurality of recesses defined therein. Each of the recesses is adapted to receive a snap ring of a cable and has an opening to the exterior of the junction box, and a channel communicating with the central connection portion. The opening and the channel of the recess define a longitudinal axis extending toward the central connection portion.

According to one preferred embodiment of the present invention, the central connecting portion is divided into two sections by a spacer. Each of the sections is adapted to receive one of the metallic ribbons, and the longitudinal axis of each of the recesses extends toward one of the two sections. Further, a first width of each of the recesses proximal to the central connection portion is larger than a second width of the each of the recesses distal to the central connection portion, and at least a part of a snap ring of the cable conforms to a part of one of the recesses.

According to another preferred embodiment of the present invention, the central connecting portion is a chamber having a bottom with apertures formed thereon to allow the metallic ribbons extending into the chamber through the apertures.

According to the other preferred embodiment of the present invention, the junction box can be a polygonal shape or a circular shape.

The characteristics of the invention will become apparent to those skilled in the art by making reference to the drawings of the invention and the following detailed descriptions of the preferred embodiments.

### BRIEF DESCRIPTION OF THE DRAWINGS

FIG. 1 illustrates one type of conventional junction box;

FIG. 2 illustrates another type of conventional junction box;

FIG. 3 illustrates a junction box according to a first preferred embodiment of the present invention;

FIG. 4 illustrates a junction box according to another preferred embodiment of the present invention;

FIG. 5 illustrates a junction box according to yet another preferred embodiment of the present invention;

FIGS. 6 and 7 illustrate the method for attaching the junction box of the present invention to a PV module;

FIG. 8 illustrates the combination of a cable with the junction box of the present invention.

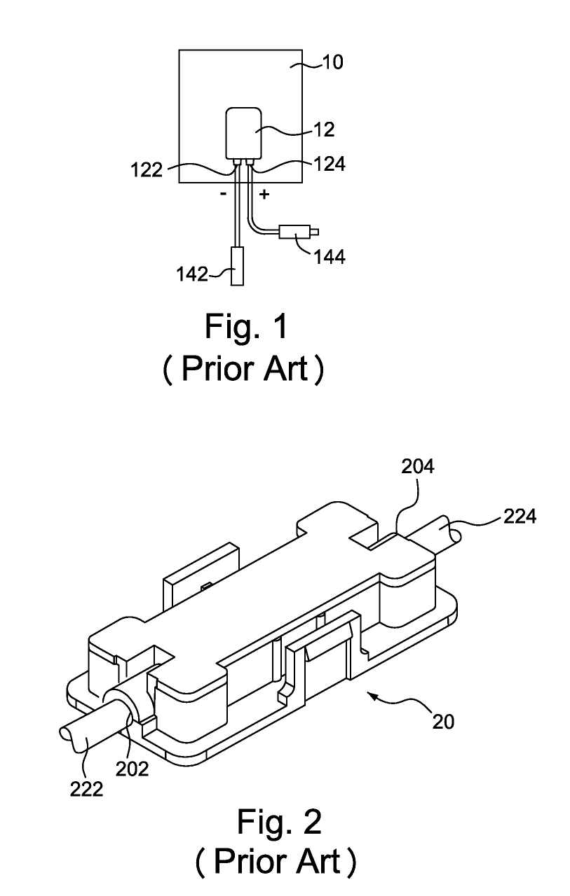

### DETAILED DESCRIPTION OF THE PREFERRED EMBODIMENTS

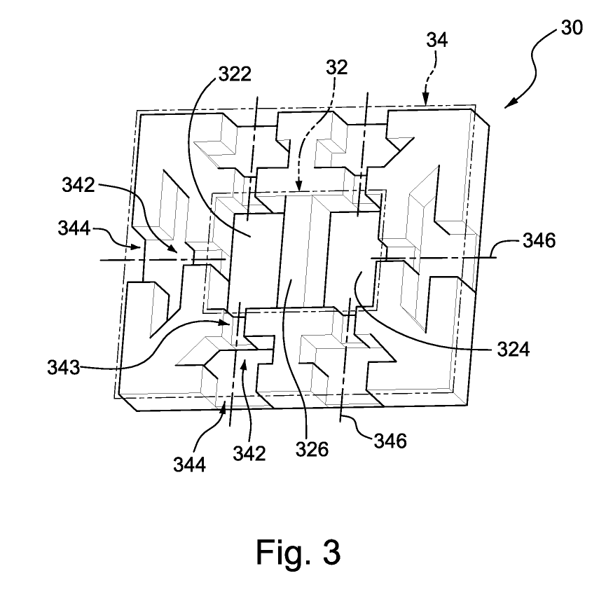

FIG. 3 illustrates a junction box according to a first preferred embodiment of the present invention. As shown in FIG. 3, the junction box 30 comprises a central connecting portion 32 and a peripheral portion 34 enclosing the central connecting portion 32. The central connecting portion 32 is in the form of a bottomless chamber that allows metallic ribbons from a PV module to extend through it. The central connecting portion 32 is divided into two sections, a first section 322 and a second section 324, by a spacer 326. Each section is configured to receive therein a ribbon extended from a positive output or a negative output of the PV module. Each of the two sections 322 and 324 is in the form of a chamber with apertures (not shown) formed thereon so that metallic ribbons are able to extend into the junction box 30 through the apertures.

Again in FIG. 3, the peripheral portion 34 comprises a plurality of recesses 342 defined around the peripheral portion 34. As illustrated, each recess 342 communicates with any one of the two sections 322 and 324. Moreover, each recess 342 has an opening 344 to the exterior of the junction box 30 so that an output cable can be received therein, and a channel 343 communicating with the central connecting portion 32. The opening 344 and the channel 343 of each recess 342 define a longitudinal axis 346 extending toward each of the two sections 322 or 324, to ensure that a core terminal of the output cable can be inserted thereinto. In this way, the junction box 30 is able to receive output cables in multiple directions. In an alternative embodiment, the central connecting portion 32 contains only one section, while the rest of the structure is the same as the first preferred embodiment.

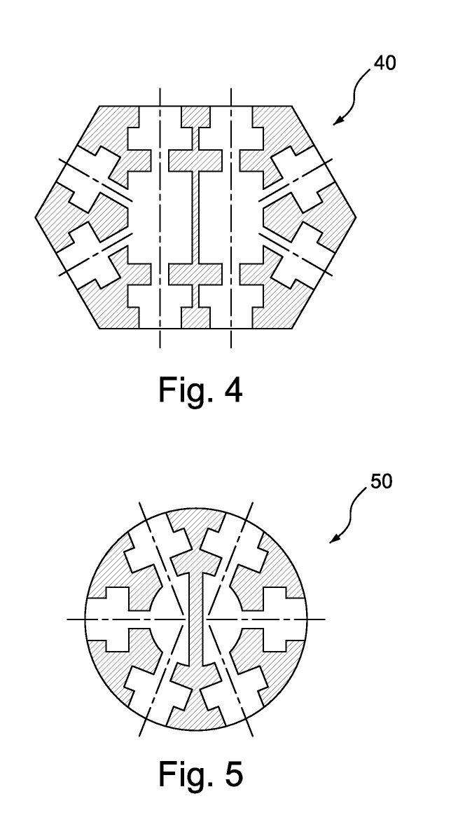

FIG. 4 illustrates a junction box according to a second preferred embodiment of the present invention. As shown in FIG. 4, the structure of the junction box 40 is generally identical to that of the junction box 30 in the first preferred embodiment. The only difference between them is that the junction box 40 presents a hexagonal shape while the junction box 30 presents a square shape. FIG. 5 illustrates a junction box 50 presenting a circular shape that can receive output cables in multiple directions. Thus, as long as the central axis of recesses extends toward the central connecting portion, the junction box of the present invention is not limited to any specific shape. The junction box of the present invention may be polygonal, circular, or any other shape as desired.

The junction box of the present invention is preferably made of insulated materials such as plastic or resin material. For example, it can be made of PPE (Polyphenylene ether), PPO (Polyphenylene Oxide) or PA (Polyamide). The junction box is also preferably made of fire-resistant material. By using these materials, the junction box of the present invention can be easily manufactured such as by injection molding.

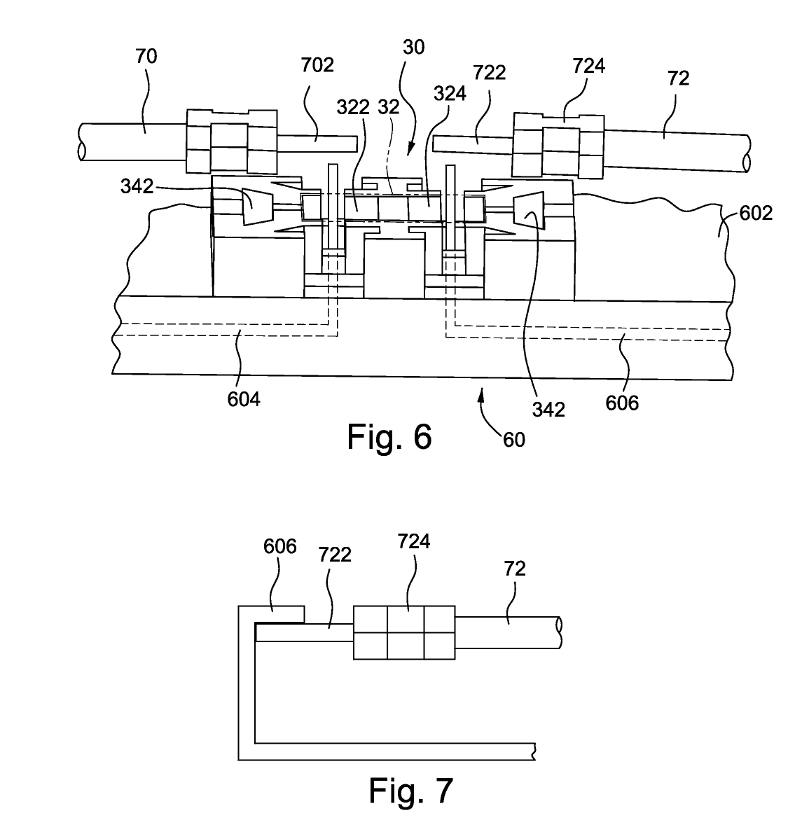

The assembling of the junction box of the present invention to a PV module is described as follows with reference to FIGS. 6 and 7. As shown in FIG. 6, the junction box 30 is first attached to a back sheet 602 of a PV module 60. A first ribbon 604 from a positive output (not shown) of the PV module 60 is extended through the first section 322. Meanwhile, a second ribbon 606 of the PV module 60 is extended through the second section 324. Then, cables 70 and 72 are placed onto the junction box 30 and then received by different recesses 342 in the desired directions so that core terminals 702 and 722 can extend into the first section 322 and the second section 324, respectively. After that, as an example shown in FIG. 7, the first ribbon 604 and the second ribbon 606 are bended to be in contact with the first core terminal 702 and the second core terminal 722, respectively. Finally, the first ribbon 604 and the first core terminal 702, and the second ribbon 606 and the second core terminal 722 are soldered together so that the electrical connection of the cable and the PV module is achieved. In some embodiments, the central section 32 may be filled with insulated sealant to prevent the solder from erosion.

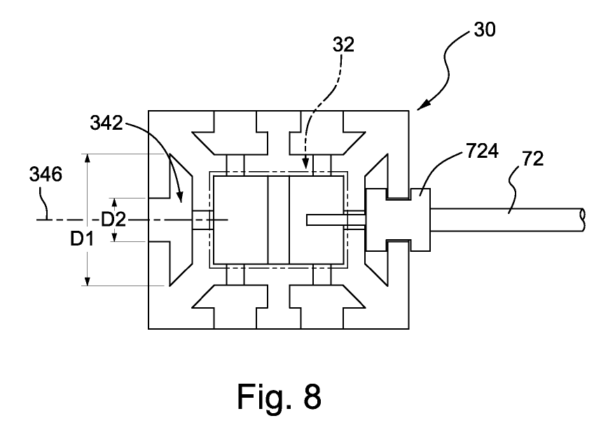

In order to secure the cable in the recess of the junction box and prevent it from being easily pulled out therefrom, the shapes of the recess of the junction box and the snap ring that loops the output cable are specially designed to achieve the purpose. As shown in FIG. 8, the recess 342 is configured to have different width along its longitudinal axis 346. Specifically, the width D1 at the inner side of the recess 342 which is proximal to the central connecting portion 32 is greater than the width D2 at the outer side of the same which is distal from the central connecting portion 32. As to the snap ring 724, it presents a “H” shape to at least partially conform to the shape of the recess 342. Thus, the arrangement of the cable 72 in the recess 342 ensures that the snap ring 724 cannot be easily pulled out from the junction box 30. In fact, the coupling of the snap ring 724 and the cable 72 is configured to sustain the pulling force up to 20 kg. Accordingly, it is unlikely to separate the cable 72 from the junction box 30 in normal use.

It should be noted that the configurations of the recess of the junction box and the snap ring of the cable are not limited to those disclosed in FIG. 8. For example, the recess and the snap ring can be a trapezoidal type having a greater width at the inner side proximal to the central connecting portion, or elastic tenon can also be applied to the snap ring so that it is able to be fixed in the recess of the junction box through snap-fit.

In summary, the junction box according to the present invention provides the following advantages:
I. Since the junction box comprises a plurality of recesses for receiving cables around the peripheral portion thereof, cables for outputting the electricity generated by PV module can be coupled to the junction box in a desired direction without unnecessary curving of the cables.
II. The configuration of the recess of the junction box can effectively fix the cable head in position, and prevent it from being pulled out easily to avoid unnecessary damage.
III. The configuration of the snap ring of the cable makes it easy for a user to install it onto the junction box, and is able to sustain the pulling force to prevent the cable from being separated from the snap ring.
IV. The junction box of the present invention can be easily manufactured at a low cost.

The invention may be implemented in other modes without departing from the spirit and the essence of the invention. Thus, the above-mentioned embodiments shall be regarded as explanatory and not restrictive. All changes compliant with the meaning and scope of the claims and the equivalents shall fall within the scope claimed by the invention.

What is claimed is:

1. A junction box configured to be used with a photovoltaic module, comprising:
a central connecting portion adapted to receive metallic ribbons extended from the photovoltaic module; and
a peripheral portion enclosing the central connecting portion, and comprising a plurality of recesses defined therein, each of the recesses being adapted to receive a snap ring of a cable;
wherein each of the recesses has an opening to the exterior of the junction box and a channel communicating with the central connection portion, through said opening and said channel, said each of the recesses defining a longitudinal axis extending toward the central connection portion.

2. The junction box according to claim 1, wherein the central connecting portion is divided into two sections by a spacer, each section adapted to receive one of the metallic ribbons, and the longitudinal axis of each of the recesses extends toward one of the two sections.

3. The junction box according to claim 1, wherein the central connecting portion is a bottomless chamber.

4. The junction box according to claim 1, wherein the central connecting portion is a chamber having a bottom with apertures formed thereon.

5. The junction box according to claims 1, wherein a first width of each of the recesses proximal to the central connection portion is larger than a second width of the each of the recesses distal to the central connection portion.

6. The junction box according to claim 1, wherein at least a part of a snap ring of the cable conforms to a part of one of the recesses.

7. The junction box according to claim 1, wherein the junction box is in polygonal shape.

8. The junction box according to claim 1, wherein the junction box is in circular shape.

9. The junction box according to claim 1, wherein the junction box is made of insulation material.

10. The junction box according to claim 1, wherein the junction box is made of fire-resistant material.

11. The junction box according to claim 1, wherein the junction box is made of resin.

12. The junction box according to claim 1, wherein the junction box is made of plastic.
